(19) United States
(12) Patent Application Publication
(10) Pub. No.: US 2026/0217472 A1
(43) Pub. Date: Jul. 30, 2026

(54) AUGER DRIVEN FEEDSTOCK INDUCTION HEATING SYSTEM

(71) Applicant: Inductotherm Corp., Rancocas, NJ (US)

(72) Inventors: Satyen N. PRABHU, Voorhees, NJ (US); Nier WU, Mount Laurel, NJ (US); Michael NUTT, West Berlin, NJ (US)

(21) Appl. No.: 19/457,331

(22) Filed: Jan. 23, 2026

Related U.S. Application Data
(60) Provisional application No. 63/749,985, filed on Jan. 27, 2025.

(51) Int. Cl. B65G 33/14; B29B 13/02; C22B 1/00

(52) U.S. Cl. CPC B65G 33/14; B29B 13/02; C22B 1/00

(57) ABSTRACT

An apparatus for preheating cold feedstock to a desired temperature prior to further processing includes a susceptor tube having an inlet and an outlet, the susceptor tube at least partially surrounded by one or more induction coils each operably connected to one or more power sources, the one or more induction coils adapted to magnetically couple to and inductively heat at least a portion of the susceptor tube. An auger is disposed coaxially within the susceptor tube along a longitudinal axis thereof, the auger adapted to rotate about the longitudinal axis to agitate and drive the feedstock from an inlet end of the susceptor tube to the outlet end of the susceptor tube.

### CROSS REFERENCE TO RELATED APPLICATIONS

This application claims the benefit of U.S. Provisional Application No. 63/749,985, filed Jan. 27, 2025, hereby incorporated by reference in its entirety.

### FIELD OF THE INVENTION

The present invention relates generally to pellet, slurry, or otherwise substantially solid feedstock heating systems, and particularly to an auger driven feedstock induction heating system for preheating or maintaining the feedstock at a desired temperature while transporting the feedstock to a final processing stage.

### BACKGROUND OF THE INVENTION

Auger driven heating systems are used in a variety of thermal process applications, often in the processing of solid, semi-solid, slurry, or pelletized feedstocks. One such feedstock is biomass, such as agricultural waste, wood and forestry residues, animal waste, and the like, which may be processed in thermal decomposition reactions (for example, pyrolysis and gasification) to produce valuable products, including bio-oil, biochar, and synthesis gas (syngas). Alternate feedstocks for such thermal decomposition processes include plastic and rubber waste, presenting a sustainable solution for recycling such waste.

Typical thermal decomposition processes utilize combustion or blast furnaces to provide the heat required to initially convert biomass, often in excess of 600° C. In the case of pyrolysis, the heat is applied in the absence of oxygen, breaking the feedstock primarily into bio-oil, with additional products of biochar and syngas. Alternatively, gasification typically operates subsequent to pyrolysis, whereupon a small, controlled amount of oxygen (or other oxidizing agent) is introduced to react with the biochar and volatile gases resulting from the pyrolysis process to result in combustion to further break down the pyrolysis products and produce combustion byproducts, including carbon dioxide and water. As additional heat is generated by combustion, the gasification step of the overall thermal process is often self-sustaining. After the combustion step, the combustion byproducts react with remaining hot reactive biochar to produce additional syngas.

Another potential use for an auger driven heating system is preheating direct reduced iron pellets. Direct reduced iron is produced from the direct reduction of iron ore in the presence of a reducing gas containing carbon and/or hydrogen at temperatures below the melting point of iron. The process of reducing iron removes oxygen contained within the iron ore and typically results in iron contents in excess of 90%, comparable to pig iron, making DRI an excellent feedstock for producing steel.

As environmental and energy concerns have increased, an industry-wide shift towards more energy efficient and environmentally friendly thermal processing has occurred. For example, in the waste conversion industry, utilization of gas fired heat sources, including blast furnaces, is the most common heat source for pyrolysis and gasification processes. However, such gas fired heat sources have several drawbacks, including implementation drawbacks such as strict environmental regulation and a higher level of operator skill required, as well as operational drawbacks, such as poor temperature control, and excessively hot environmental conditions for operators.

Similarly, in the steelmaking industry, many steelmakers have begun shifting from traditional blast furnace processes to electric arc furnaces (EAF) using DRI as a feedstock. EAF processes typically require significantly less energy and produce drastically reduced amounts of carbon dioxide and other contaminants than equivalent blast furnace processes. Additionally, traditional EAF processes use scrap iron and steel as a feedstock which varies in composition, often resulting in slag and dust that can contain toxic materials, such as zinc, lead, dioxins, and other heavy metals, and therefore increase air pollution. By supplementing or replacing scrap iron and steel usage, these environmental concerns can be reduced.

In some cases, where DRI is produced on-site, the DRI is transported hot from the reduction furnace to the electric arc furnace to reduce energy consumption of the EAF to bring the DRI to melting temperatures. It is known in the art to incorporate heating systems into the feed legs of a direct reduction furnace to maintain the resultant hot DRI at an elevated temperature as it is transported to the EAF, or otherwise recapture heat contained within off-gas produced during the direct reduction process to maintain the hot DRI at an elevated temperature.

However, steelmakers converting from a traditional blast furnace steelmaking process often do not have on-site access to DRI production facilities and therefore utilize cold DRI feedstock. Charging cold DRI feedstock into an EAF requires significantly more energy to raise the DRI feedstock to melting temperatures than using pre-heated DRI feedstock, obviating one of the primary benefits of switching to an EAF process. Similarly, cold DRI feedstock requires more time to raise to melting temperatures by the EAF, reducing throughput of the steelmaking process. Ideally, DRI entering the EAF at temperatures in the range of 500-600° C. is preferred to reduce energy consumption and operational time of the EAF.

Induction heating processes represent one of the most environmentally friendly and energy efficient methods of heating materials, either directly through inductively coupling with the material to be heated, or via conduction through contact with an inductively heated substrate, also known as a susceptor. Induction heating further can be precisely controlled to ensure the desired temperature is reached accurately and rapidly. As such, induction heating represents an ideal method for heating or preheating solid, slurry, or otherwise pelletized feedstock for further processing or to produce a desired end product.

Therefore, there is a need for an independent induction heating system for heating or preheating cold feedstock, including direct reduced iron feedstock pellets, biomass, plastic waste, agricultural stubble, or other feedstocks, prior to delivery to a downstream processing apparatus, the induction heating system distinct, separate, and independent from an existing upstream processing apparatus, such as direct reduction furnace systems.

### BRIEF SUMMARY OF THE INVENTION

In one aspect, the present invention is a system for preheating cold feedstock to a desired temperature prior to further processing comprising a susceptor tube having an inlet and an outlet, the susceptor tube at least partially surrounded by one or more induction coils each operably connected to one or more power sources, the one or more induction coils adapted to magnetically couple to and inductively heat at least a portion of the susceptor tube. An auger is disposed coaxially within the susceptor tube along a longitudinal axis thereof, the auger adapted to rotate about the longitudinal axis to drive the feedstock from an inlet end of the susceptor tube to the outlet end of the susceptor tube.

In another aspect, the present invention is a method for preheating cold feedstock to a desired temperature prior to further processing comprising inductively heating a susceptor tube with one or more induction coils at least partially surrounding the susceptor tube, charging a feedstock into a susceptor tube, transporting the feedstock from a first end of the susceptor tube to a second end of the susceptor tube via an auger, wherein the auger agitates the feedstock to distribute contact with the susceptor tube across the feedstock, thereby distributing heat conducted and induced into the feedstock along the susceptor tube.

The above and other aspects of the present invention are set forth in this specification and the appended claims.

### BRIEF DESCRIPTION OF THE DRAWINGS

The drawings, as briefly summarized below, are provided for exemplary understanding of the invention, and do not limit the invention as further set forth in this specification and the appended claims.

FIG. 1(a) illustrates a perspective view of one example of the auger driven feedstock induction heating system of the present invention.

FIG. 1(b) illustrates a plan view of the auger driven feedstock induction heating system of FIG. 1(a).

FIG. 1(c) illustrates a top plan view of the auger driven feedstock induction heating system of FIG. 1(a).

FIG. 1(d) illustrates a front plan view of the auger driven feedstock induction heating system of FIG. 1(a).

FIG. 2(a) illustrates a schematic view of the auger driven feedstock induction heating system showing the internal auger drive system.

FIG. 2(b) illustrates a plan view of a variable pitch auger of the auger driven feedstock induction heating system.

FIG. 3(a) illustrates a perspective view of one example of an induction heating unit of the auger driven feedstock induction heating system of the present invention.

FIG. 3(b) illustrates a front plan view of one example of an induction heating unit of the auger driven feedstock induction heating system of the present invention.

FIG. 3(c) illustrates a cross-sectional view of the induction heating unit of FIG. 3(b) taken along line A-A.

FIG. 3(d) illustrates a cross-sectional view of the induction heating unit of FIG. 3(a) taken along line B-B.

FIG. 4(a) illustrates a perspective view of one example of the induction coil of the auger driven feedstock induction heating system of the present invention, the induction coil comprising a solenoidal coil construction.

FIG. 4(b) illustrates a perspective view of the induction coil of FIG. 3(a) heating the susceptor tube of the auger driven feedstock induction heating system of the present invention.

FIG. 5(a) illustrates a perspective view of an alternate example of the induction coil of the auger driven feedstock induction heating system of the present invention, the induction coil comprising a curved pancake coil construction.

FIG. 5(b) illustrates a perspective view of the induction coil of FIG. 4(a) heating the susceptor tube of the auger driven feedstock induction heating system of the present invention.

### DETAILED DESCRIPTION OF THE INVENTION

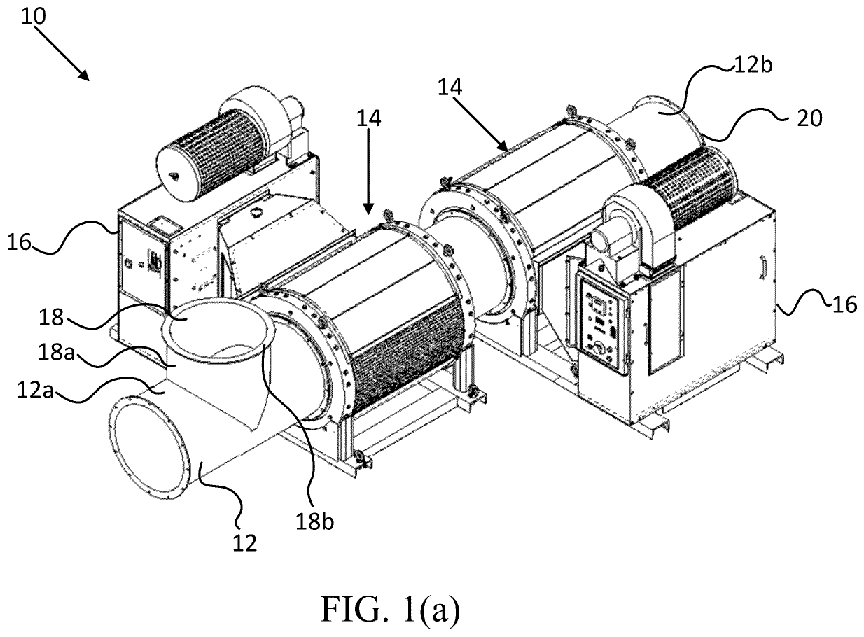

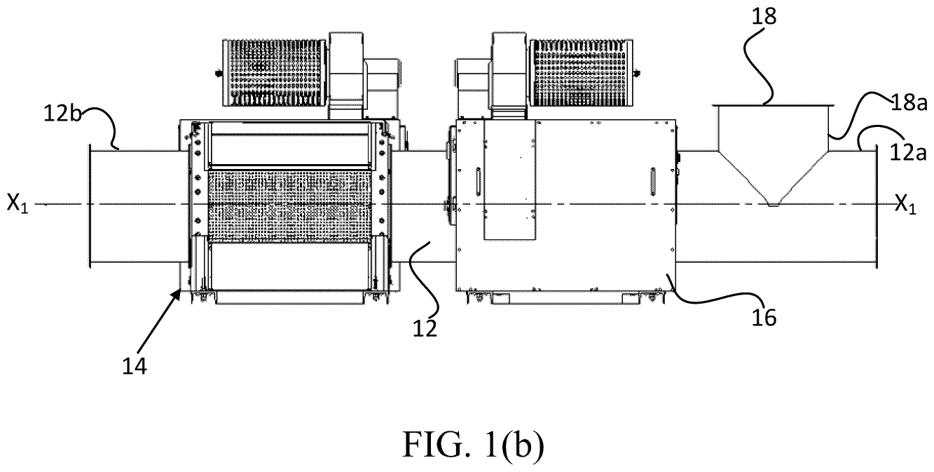

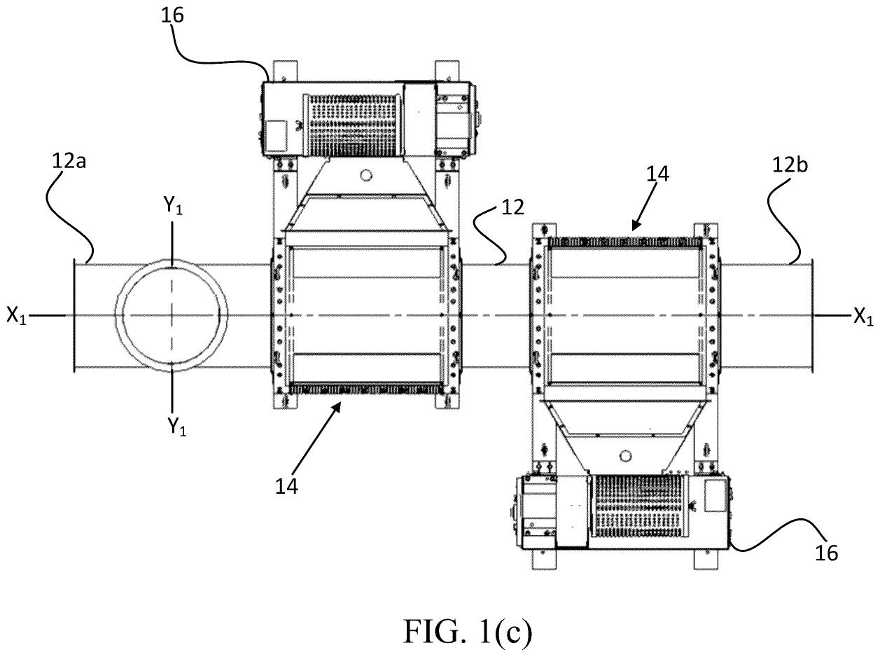

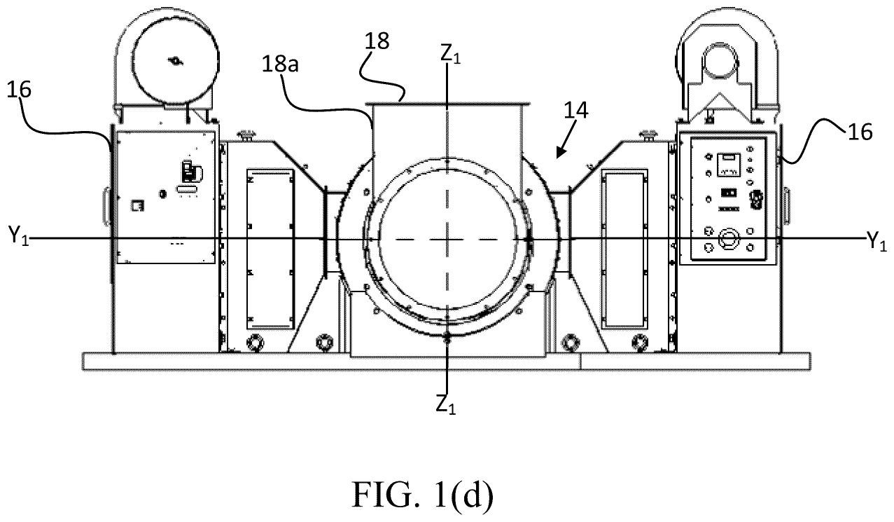

Referring now to the drawings, wherein like numerals indicate like elements, there is shown in FIG. 1(a) through 1(d), in accordance with the present invention, examples of an auger driven feedstock induction heating system.

For the purposes of illustration, the following disclosure discusses the present invention in relation to preheating cold direct reduced iron (DRI) pellets in a batch process prior to charging into an electric arc furnace (EAF) for steelmaking, however it should be understood that the present invention may further be utilized for the purpose of heating other solid, slurry, or pelletized feedstock suitable for various end uses, including biomass pyrolysis, plastic melting, agricultural stubble processing, or other processes requiring preheating the feedstock prior to charging the feedstock into alternative downstream processing apparatuses in a batch or continuous process. Similarly, the present invention is not limited to induction heating of electrically conductive feedstock materials, such as DRI pellets, and should be understood to function similarly with non-electrically conductive pelletized or otherwise dimensioned feedstock.

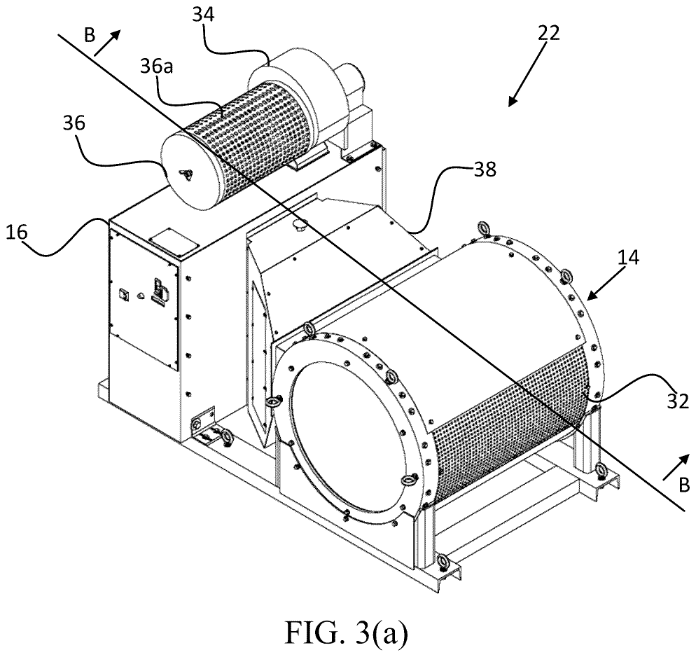

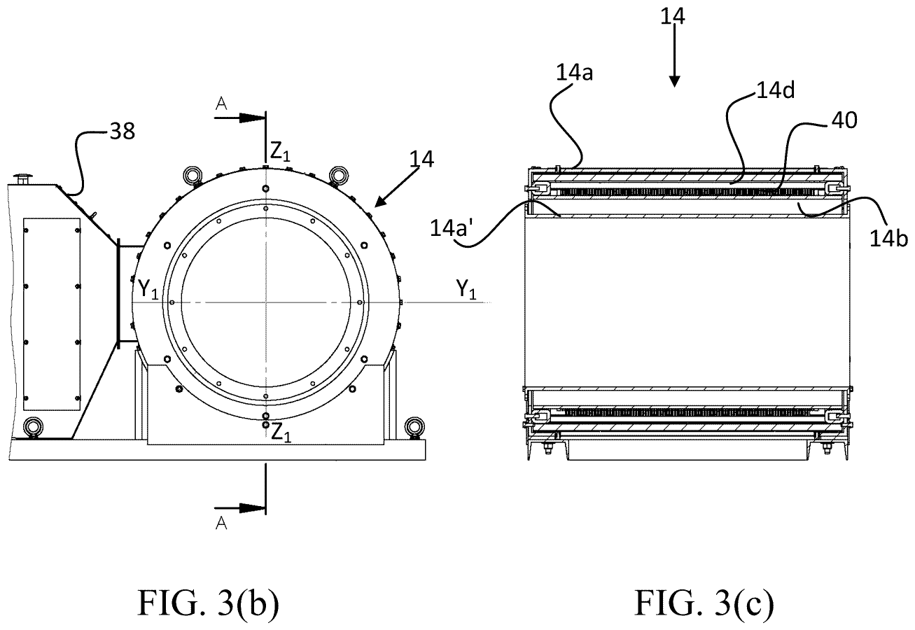

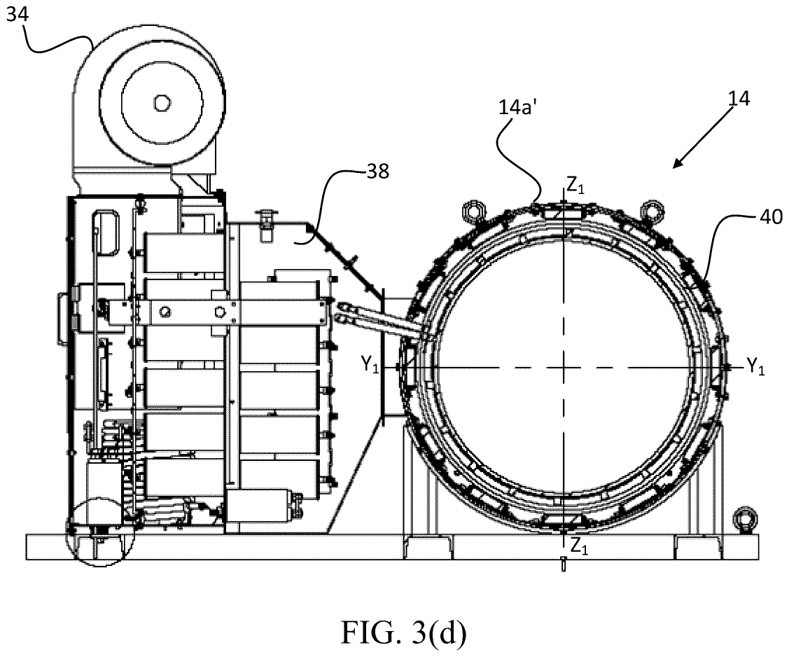

The auger driven feedstock induction heating system 10 includes a susceptor tube 12 comprising an electrically conductive material, wherein at least a portion of the susceptor tube 12 is positioned to magnetically couple with one or more induction coils (as shown in FIG. 3(c), 40) disposed in proximity to the susceptor tube 12, the one or more induction coils disposed within one or more induction coil assemblies 14 as part of one or more induction heating units (as shown in FIG. 3(a), 22) as further described elsewhere herein. In an alternate embodiment, the susceptor tube 12 may comprise a trough structure, wherein an upper side of the susceptor tube 12 is at least partially open. In the illustrated embodiment, the one or more induction coil assemblies 14 surround an entire circumference of the susceptor tube 12, however, as further described elsewhere herein, the one or more induction coils disposed within the induction coil assemblies 14 may comprise various induction coil topologies magnetically coupling with an entire circumference of the susceptor tube 12, or alternately only a portion of the circumference of the susceptor tube 12. In some such embodiments, the one or more induction coil assemblies 14 conform to the shape of the induction coil disposed therein, such that in emboidments featuring an induction coil topology only partially surrounding the susceptor tube 12, the one or more induction coil assemblies 14 define a saddle, semi-circular, or U-shaped coil housing to partially surround the circumference of the susceptor tube 12. In the shown embodiment, the one or more induction coil assemblies 14 are disposed along an axial length of the susceptor tube 12, defining one or more heating segments adapted to inductively heat the susceptor tube 12 along a majority of the axial length of the susceptor tube 12. In the illustrated embodiments, a pair of induction heating units are utilized, however, it should be understood that for differing axial lengths of the susceptor tube 12, additional induction heating units may be supplied along an entire axial length thereof. In the shown embodiment, adjacent induction heating units of the one or more induction heating units are disposed opposite each other along the length of the susceptor tube 12 to provide access to control panels necessary to operate the one or more induction heating units when sequential induction heating units are placed in close proximity to each other. The induction coil assemblies 14 may be spaced apart from each other along the axial length of the susceptor tube 12 to accommodate structures extending from or attached to the susceptor tube 12, such as gas inlet openings or exhaust outlet pipes, as elsewhere described herein. Alternatively, where such structures are not present, adjacent induction coil assemblies 14 may be placed in direct contact with each other to maintain a consistent heating profile across the axial length of the susceptor tube 12.

Each induction coil of the one or more induction coils may be separately connected to independent power sources 16, for example as part of one or more induction heating units as further described elsewhere herein, allowing variations in power level and frequency provided to each induction coil. In some such embodiments, the one or more induction coils comprise a multi-stage configuration wherein an amount of energy transferred to the susceptor tube 12 progressively increases or decreases relative to an axial position of the induction coil along the susceptor tube 12. In this manner, the susceptor tube 12 may comprise a temperature gradient along its axial length to bring and a feedstock material to a desired temperature and maintain the feedstock at that desired temperature until the feedstock exits the susceptor tube 12. In a preferred embodiment, the desired temperature is in the range of 500-600° C. An overall length of the susceptor tube 12, as well as a residence time of the feedstock within the susceptor tube 12, may be adjusted in addition to operational parameters of the induction coil to achieve the desired temperature, which may further be controlled via feedback received by one or more temperature sensors disposed within the susceptor tube 12 as further described elsewhere herein. In an alternate embodiment, the one or more induction coils are simultaneously controlled to have equivalent operational frequencies and power levels to present a uniform heating profile along the axial length of the susceptor tube 12.

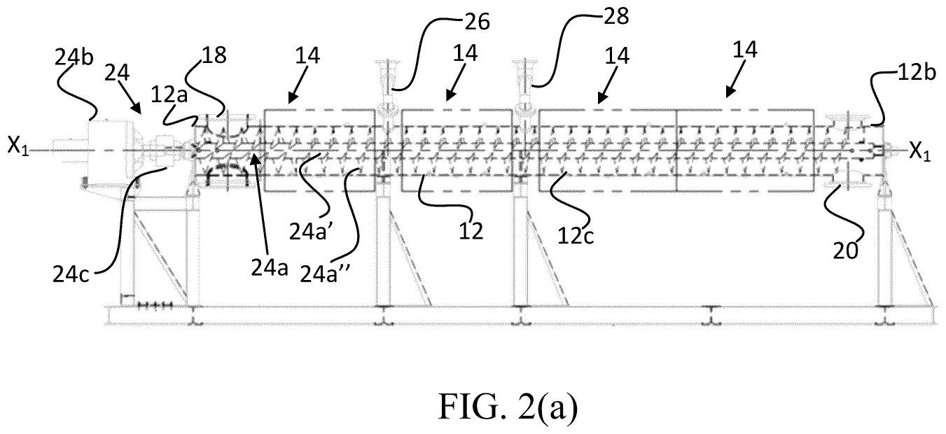

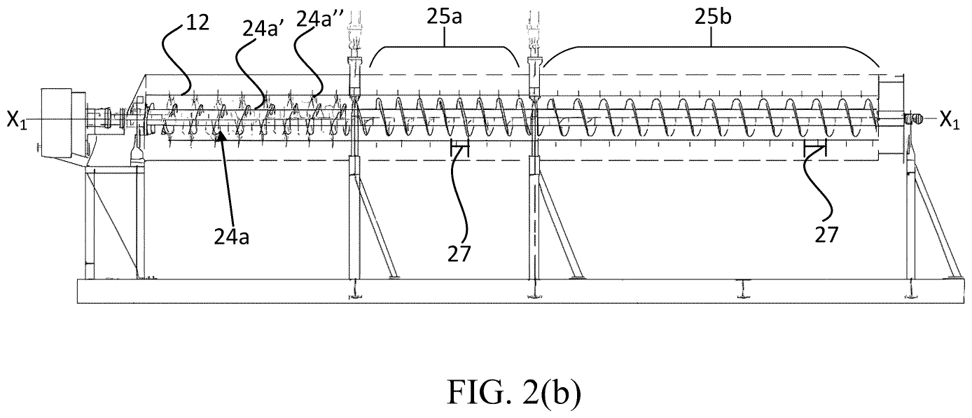

The susceptor tube 12 further comprises a feedstock inlet opening 18 proximate to a first end 12a thereof and one or more feedstock outlet openings 20 proximate to a second end 12b thereof. In the illustrated embodiment, the feedstock inlet opening 18 is disposed through an upper side of the susceptor tube 12, while the feedstock outlet opening 20 is disposed perpendicular to the feedstock inlet opening 18 and coincides with the second end 12b of the susceptor tube 12. In some such embodiments, the second end 20 is adapted to secure to an outlet or downstream processing apparatus via a securing flange disposed about the perimeter of the second end 12b. In such embodiments, an auger, as further described elsewhere herein, drives a feedstock, such as a plurality of direct reduced iron (DRI) pellets through the second end 20 of the susceptor tube 12 for downstream processing. In the alternate embodiment shown in FIG. 2(a), the feedstock inlet opening 18 is disposed through an upper side of the susceptor tube 12 opposite from the at least one feedstock outlet opening 20, wherein the at least one feedstock outlet opening 20 is disposed through a lower side of the susceptor tube 12. In this manner, the feedstock, enters and exits the susceptor tube 12 via gravity feed. The plurality of DRI pellets is heated primarily via conduction through direct contact with the heated susceptor tube 12, as well as contact with other heated DRI pellets of the plurality of DRI pellets. While the plurality of DRI pellets comprise an electrically conductive material capable of coupling to the magnetic field produced by the induction coils, agitation of the plurality of DRI pellets during transit across the length of the susceptor tube 12 reduces coupling efficiency with the plurality of DRI pellets, such that inductive heating is minimal in comparison to conductive heating through contact with the susceptor tube 12. In this manner, the present system may be utilized in combination with alternate non-electrically conductive feedstock materials with minimal impact to feedstock heating quality.

In the illustrated embodiment, the feedstock inlet opening 18 further is offset from an exterior surface via an extension tube segment 18a of the susceptor tube 12 defining a hopper adapted to collect the plurality of DRI pellets from a feedstock source and direct the plurality of DRI pellets to an interior of the susceptor tube 12. In some such embodiments, the extension tube segment 18a may further taper radially outward towards a distal end thereof, such that the distal end of the extension tube segment 18a defines a larger circumferential opening than the feedstock inlet opening 18. In some embodiments, the extension tube segment 18a further comprises a flange 18b about a distal end thereof adapted to connect to a feed line from the feedstock source. In one embodiment, for each batchwise DRI pellet heating process, the plurality of DRI pellets comprise a quantity of DRI pellets sufficient to fill approximately half of an interior volume of the susceptor tube 12. In alternate embodiments utilizing a continuous DRI pellet heating process, a charging rate of the plurality of DRI pellets or other feedstock is controlled to ensure no more than approximately half of the interior volume of the susceptor tube 12 is filled at any time. In this manner, as the plurality of DRI pellets travel along the length of the susceptor tube 12, each DRI pellet is assured sufficient contact with the heated portions of the susceptor tube 12 and other proximate heated DRI pellets such that heat transfer into the plurality of DRI pellets is distributed evenly to each DRI pellet of the plurality of DRI pellets.

As best illustrated in FIG. 2(a), the auger driven feedstock heating system further comprises an auger 24a (screw conveyor) extending coaxially through the susceptor tube 12 along a longitudinal axis X₁ of the susceptor tube 12. The longitudinal axis X₁ is disposed centrally within the susceptor tube 12, bisecting a pair of perpendicular transverse axes of the susceptor tube 12 (Y₁ and Z₁, as best illustrated in FIG. 1(d)). The auger 24a is operably connected to an auger motor 24b adapted to rotate the auger 24a about the longitudinal axis X₁ to drive the plurality of DRI pellets along the length of the susceptor tube 12, defining an auger assembly 24. The auger 24a may comprise an electrically conductive material which may experience inductive heating from the one or more induction coils, however, it is of primary concern that the auger 24a comprise a material having sufficient thermomechanical properties to operate at the desired temperature range of 500-600° C. without appreciable losses of material strength compared to a baseline ambient room temperature. In the shown embodiment, the auger assembly 24 is affixed to the susceptor tube 12 to extend through the first end 12a thereof, wherein the auger motor 24b is disposed external to the susceptor tube 12. The auger 24a comprises an auger blade 24a′ helically wrapped about a central axle 24a'', wherein a radial length of the auger blade 24a′ is dimensioned to be within close tolerance of an inner surface 12c of the susceptor tube 12. The auger blade 24a′ is contemplated to be angled in an offset manner from a plane perpendicular to the central axle 24a″ (auger pitch), such that a distal end of the auger blade 24a′ is positioned forward relative to a base of the auger blade 24a′ along the axial length of the central axle 24a″. In this manner, a radial distance between the auger blade 24a′ and the inner surface 12c comprises a distance less than a diameter of a typical DRI pellet of the plurality of DRI pellets. This ensures that each DRI pellet of the plurality of DRI pellets is entrained by the auger 24a during a pellet heating process to translate along the length of the susceptor tube 12, while also agitating the plurality of DRI pellets to ensure each pellet of the plurality of DRI pellets contacts the heated portions of the susceptor tube 12.

The rotation speed of the auger 24a, as governed by the auger motor 24b, may be adjustable to vary the translation speed of the plurality of DRI pellets through the susceptor tube 12, and therefore the residence time of the plurality of DRI pellets within the susceptor tube 12. Furthermore, the auger motor 24b may be configured to oscillate the rotation direction in an alternating fashion periodically to prevent feedstock clumping, bridging, or other occlusions, while improving feedstock agitation and heat distribution through the feedstock. In this manner, the frequency of the rotational oscillation may be preset by a user or selectively adjusted over the course of operation by a control system in response to feedback from flowrate sensors tracking the flowrate of the feedstock along the axial length of the susceptor tube 12 or temperature sensors detecting the heat distribution through the feedstock as further described elsewhere herein. In some embodiments, the pellet translation speed may be adjusted throughout the pellet heating process to vary the residence time within the susceptor tube 12 in response to feedback from one or more thermocouples or other temperature sensors adapted to determine a heat distribution through the plurality of DRI pellets as further described elsewhere herein.

In the illustrated embodiment, the auger 24a is further operably connected to an axial oscillating motor 24c, wherein the axial oscillating motor 24c is configured to oscillate the auger 24a along the longitudinal axis of the auger axle 24a″ to improve feedstock agitation and heat distribution therethrough. The frequency and amplitude of the axial oscillation may be preset by a user or selectively adjusted over the course of operation by a control system in response to feedback from flowrate sensors tracking the flowrate of the feedstock along the axial length of the susceptor tube 12 or temperature sensors detecting the heat distribution through the feedstock as further described elsewhere herein.

In the illustrated embodiment, the susceptor tube 12, or in some embodiments, the induction heating unit, is further mounted on a support structure elevating the susceptor tube 12 above a work deck level. In some embodiments, the support structure is adapted to tilt the susceptor tube 12 relative to the work deck, such that the first end 12a of the susceptor tube 12 is elevated relative to the second end 12b of the susceptor tube 12. In this manner, movement of the plurality of DRI pellets along the axial length of the susceptor 12 is gravity assisted, such that energy input to the auger motor 24b may be reduced, while simultaneously reducing abrasion to the auger blade 24a′ as the conveying force supplied by the auger 24a is reduced. In such embodiments, individual legs of the support structure may be adjustable in length to selectively adjust the tilt angle of the susceptor tube 12 from the first end thereof to the second end thereof. Alternatively, individual induction heating units (as best illustrated in FIG. 3(a), 22) disposed along the length of the susceptor tube 12 may be mounted to the work deck at differing heights to achieve a desired tilt angle. In such embodiments, the induction coil assembly 14 is oriented to accommodate the tilt angle of the susceptor tube 12. In some embodiments, the induction coil assembly 14 is adjustably mounted to the induction heating unit, such that the induction coil assembly 14 is configured to rotate to accommodate various tilt angles of the susceptor tube 12.

As shown in FIG. 2(b), a pitch (pitch angle) of the auger blade 24a′ may vary along an axial length of the auger 24a to adjust feedstock flow, agitation, and volume relative to the auger 24a. As the pitch of the auger blade 24a′ changes, a spacing 27 disposed linearly along the axial length of the auger 24a between adjacent turns of the auger blade 24a′, and therefore the volume of feedstock entrained by each auger blade 24a′ turn changes. The auger 24a is contemplated to comprise a constant pitch auger, as shown in FIG. 2(a), a variable pitch auger, as shown in FIG. 2(b), or a gradual pitch auger (not shown). The constant pitch auger is defined by an auger blade 24′ having a consistent pitch from a proximal end of the auger 24a (proximate to the feedstock inlet opening) to a distal end of the auger 24a (proximate to the feedstock outlet opening), such that the spacing 27 between each adjacent turn of the auger blade 24a′ is equivalent. In this manner, no substantive feedstock flow and heating parameters change along the axial length of the auger 24a as a result of auger blade 24a′ pitch. Alternatively, the auger blade 24a′ of the variable pitch auger comprises one or more localized pitch variations defining a plurality of pitch segments 25a and 25b, each having a distinct pitch angle, wherein the pitch of the auger blade 24a′ within each pitch segment of the plurality of pitch segments 25a and 25b is constant, which in combination with an individual induction coil, define one or more staged heating zones along the axial length of the auger 24a. For example, in a variable pitch angle auger, the spacing 27 between adjacent turns of the auger blade 24a′ is consistent within each pitch segment and the spacing 27 of the auger blade 24a′ within each pitch segment varies relative to each remaining pitch segment. In this manner, localized flow and heating parameters vary relative to each distinct pitch segment. Finally, the gradual pitch auger is defined by a gradually increasing pitch of the auger blade 24a′ along the axial length of the auger 24a, such that the pitch is lower proximate to the feedstock inlet opening and higher proximate to the feedstock outlet opening, such that an initial auger blade spacing as defined between adjacent turns of the auger blade 24a′ proximate to the feedstock inlet opening is reduced relative to each subsequent auger blade spacing 27 as defined between adjacent turns of the auger blade 24a′ disposed along the axial length of the auger axle 24a″. As such, the spacing 27 gradually increases from the proximal end of the auger 24a to the distal end of the auger 24a. In this manner, the feedstock flow and heating parameters gradually change relative to the axial length of the auger 24a, such that flow of the feedstock at the feedstock inlet opening is controlled more closely, moving smaller volumes of feedstock at a faster continuous rate, while the flow of the feedstock at the feedstock outlet opening moves larger volumes of feedstock. In some embodiments, a plurality of augers are used in combination with the auger driven feedstock induction heating system of the present invention, wherein the plurality of augers comprises the constant pitch auger, the variable pitch auger, and the gradual pitch auger, wherein each auger of the plurality of augers is interchangeable to suit various operational parameters, including feedstock type, size, flowrate, and the like. In this manner, the present invention may be flexibly used to heat feedstocks for a variety of end uses.

In the illustrated embodiment of FIG. 2(a), one or more gas inlet pipes 26 are disposed through the susceptor tube 12 between adjacent induction coil assemblies 14. The one or more gas inlet pipes 26 are operably connected to an inert gas source, such that an inert gas atmosphere may be maintained within the interior of the susceptor tube 12 during the DRI pellet heating process. In some embodiments, the inert gas comprises nitrogen, however alternate inert gases are also contemplated. In this manner, oxidation and other undesirable chemical reactions that may occur under a typical room air atmosphere may be avoided. Alternatively, the one or more gas inlet pipes 26 may be in communication with a reactive gas source, the reactive gas selected to react with the feedstock to produce a desired resultant product when the feedstock is inductively heated. Additionally, in some embodiments, one or more exhaust pipes 28 are disposed through the susceptor tube 12, wherein the one or more exhaust pipes 28 are adapted to remove off-gas produced as the plurality of DRI pellets are heated. In some such implementations, the inert gas is circulated through the one or more gas inlet pipes 26 and the one or more exhaust outlet pipes 28 to simultaneously maintain an inert gas blanket within the susceptor tube 12 and vent any undesirable off-gas extracted from the plurality of DRI pellets. In such embodiments, the rate of circulation is adjusted to maintain a constant internal pressure within the susceptor tube 12. In another embodiment, the one or more gas inlet pipes 26 and the one or more exhaust outlet pipes 28 are in communication with a vacuum motor to generate a vacuum within the susceptor tube 12.

In the illustrated embodiment of FIG. 3(a) through 3(d), an induction heating unit 22 is shown comprising an induction coil assembly 14 operably connected to a power source 16, wherein the power source 16 is optionally in communication with a control system for selectively varying induction coil 40 operational parameters, such as power magnitude (through adjustable current magnitude and voltage magnitude supplied to the induction coil 40) and frequency supplied to the induction coil 40. The induction heating unit 22 is contemplated to comprise a unitary construction, such that the power source 16 and induction coil assembly 14 comprise an individual induction heating unit 22 to be applied about a susceptor tube 12 as elsewhere described herein. In this manner, any number of induction heating units 22 may be utilized in combination with susceptor tubes 12 of differing lengths and geometries. In embodiments featuring a control system, the auger motor and the axial oscillating motor may further be in communication with the control system, such that the rotational speed, the rotational oscillation frequency, the axial oscillation amplitude, and the axial oscillation frequency can be adjusted by output signals produced by the control system. By way of example, the control system may be in communication with one or more temperature sensors disposed throughout the susceptor tube 12, wherein the one or more temperature sensors are configured to monitor the temperature of the susceptor tube 12 along an entire length thereof throughout operation and one or more flowrate sensors disposed throughout the susceptor tube 12, wherein the one or more flowrate sensors are configured to monitor the flowrate of the feedstock through the susceptor tube 12 along an entire length thereof. In this manner, the control system is configured to receive feedback from the one or more temperature sensors and the one or more flowrate sensors to adjust a traversal speed, of the plurality of DRI pellets through the susceptor tube 12, and therefore a residence time of the plurality of DRI pellets within the susceptor tube 12, to account for variations in temperature along a length thereof to ensure that the plurality of DRI pellets are heated to a desired temperature prior to exiting the susceptor tube 12. Additionally, the control system is configured to selectively adjust the rotational oscillation frequency and the axial oscillation frequency to agitate the plurality of DRI pellets within the susceptor tube 12 to control the heat distribution through the feedstock or the flowrate of the feedstock through agitation. For example, upon detecting an unexpected reduced flowrate indicating a potential occlusion, the control system may selectively increase one or more of the rotational oscillation frequency or the axial oscillation frequency to break up the occlusion. Adjustment of the operational parameters through operation is contemplated to be manually input by an operator, or alternatively, automatically implemented by the control system following one or more known empirical or analytical heat distribution models.

The induction coil assembly 14 comprises a substantially tubular coil housing 14a within which an induction coil 40 is disposed, as best illustrated in FIG. 3(c). In the shown embodiment, the induction coil 40 comprises a solenoidal multiturn construction, however, as further described elsewhere herein, alternate coil designs and structures are contemplated for heating substantially an entire circumference of the susceptor tube or a portion of the circumference of the susceptor tube, for example pancake type induction coils. Two or more induction heating units 22 may be secured to the susceptor tube such that the susceptor tube passes through each induction coil assembly 14 of the induction heating units 22. As previously described, when multiple induction heating units 22 are placed sequentially along a length of the susceptor tube, the induction coil 40 of each induction heating unit 22 may be operably connected to an independent power source 16, or alternatively, each induction coil may be operably connected to a single power source 16. Each independent power source 16 may further be controlled by a singular control system, as previously discussed, to adjust and control the heating profile generated in the susceptor tube. In this manner, the one or more induction coils 40 may comprise equivalent or varied operational parameter inputs as necessary to suit the desired heating process.

As shown in FIG. 3(c), the induction coil assembly 14 comprises a coil housing 14a having an inner diameter dimensioned to conform to an outer diameter of the susceptor tube, such that the induction coil 40 is placed in proximity to the susceptor tube. As an alternating current is applied to the induction coil 40, the magnetic field generated by the induction coil 40 is adapted to magnetically couple with the susceptor tube, inducing heating therein. The magnetic field may be precisely controlled to maximize coupling directly with the plurality of DRI pellets or other electrically conductive feedstock flowing through the susceptor tube to improve heating efficiency. Alternatively, the magnetic field may be further controlled to prevent interference with equipment in the surrounding area. For example, the induction coil assembly 14 may further comprise shunts disposed on each side of the induction coil 40 and Faraday rings disposed on each end of the induction coil 40 to control stray magnetic field lines. In some embodiments, the induction coil is seated within a flux concentrator 14d to further redirect the magnetic field to the susceptor tube and to control magnetic coupling to additional elements, such as the plurality of DRI pellets and the auger. A layer of refractory material 14b may further be disposed between the induction coil 40 and an inner wall 14a′ of the coil housing 14a, such that heat induced into the susceptor tube in direct contact with the inner wall 14a′ is not transferred to the induction coil 40.

In the illustrated embodiments, the one or more induction coils 40 of each induction heating unit 22 are air-cooled. The induction heating units 22 further comprise a blower unit 34 adapted to collect air from the surrounding atmosphere and drive the air through a connected air channel 38 disposed between the blower unit 34 and the induction coil assembly 14, as best illustrated in FIG. 3(d), wherein the air channel 38 is in communication with an interior of the coil housing 14a. In this manner, the collected ambient air (cooling air) is driven over the exterior of the induction coil 40 to cool the induction coil 40 via forced convection. In the illustrated embodiment, the blower unit 34 is affixed to a cabinet containing the power source 16 and is further connected to the induction coil assembly 14 via a conduit containing the air channel 38. In this manner, the cooling air is collected via the blower unit 34, directed to the air channel 38 disposed within the conduit, and to the interior of the coil housing 14a. In some embodiments, the blower unit 34 further comprises an air filter adapted to remove debris or other contaminants from the air collected thereby prior to delivery to the coil housing 14a via the air channel 38. In the shown embodiment, a shroud 36 is disposed over the blower unit 34, the shroud 36 having a plurality of inlet apertures 36a therethrough, wherein the plurality of inlet apertures 36a is dimensioned to prevent dust, debris, or other undesirable materials entrained in the collected air from entering the blower unit 34. In such embodiments, the shroud 36 may be used in combination with a supplemental air filter disposed within the shroud 36 between the shroud 36 and the blower unit 34, or alternatively, the shroud 36 may operate as the primary means of air filtration without the supplemental air filter. In the illustrated embodiment, a plurality of exhaust apertures 32 is disposed through at least a portion of the coil housing 14a, the plurality of exhaust apertures 32 providing an exit for the cooling air flowing over the induction coil 40.

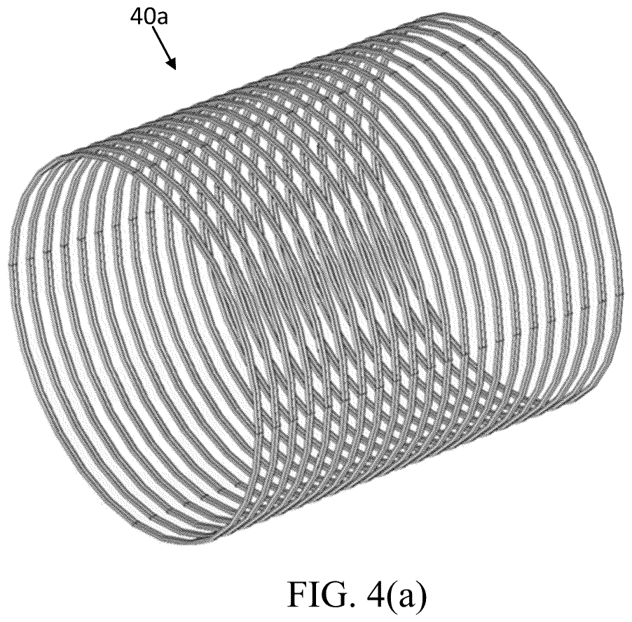

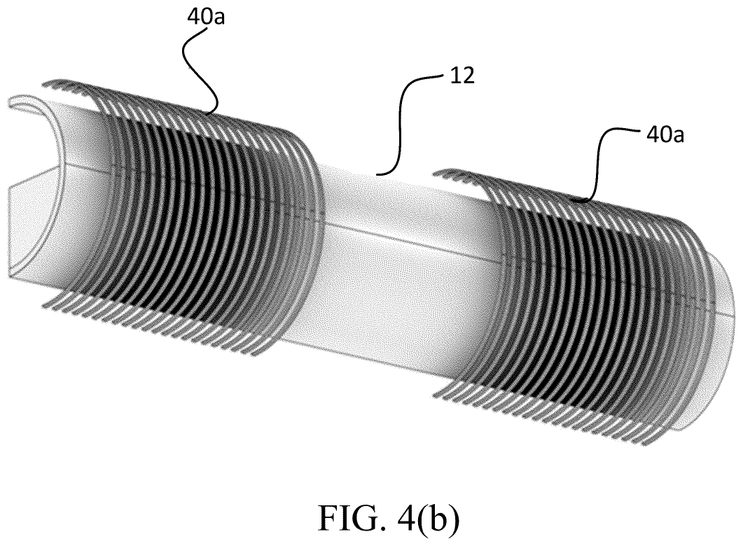

As illustrated in FIGS. 4(a) and 4(b), there is shown one example of the induction coil 40a disposed within the induction coil assembly of the induction heating unit as previously described. The shown induction coil 40a comprises a multiturn solenoidal construction adapted to surround an entire exterior circumference of the susceptor tube 12. The induction coil 40a comprises a constant diameter, such that the induction coil 40a is disposed at a uniform and consistent distance from the susceptor tube 12. As best illustrated in FIG. 4(b), the induction coil 40a thereby induces heat into the susceptor tube 12 about an entire circumference thereof. However, as the plurality of DRI pellets occupy and contact only a lower portion of the susceptor tube 12 through the entire pellet heating process, heating an upper portion of the susceptor tube 12 as shown reduces the efficiency of the induction coil 40a as heat induced into the upper portion is not transferred into the plurality of DRI pellets. In the illustrated embodiment, the induction coil 40a comprises a Litz wire construction, however in alternate embodiments, internally cooled tubular induction coils may be used.

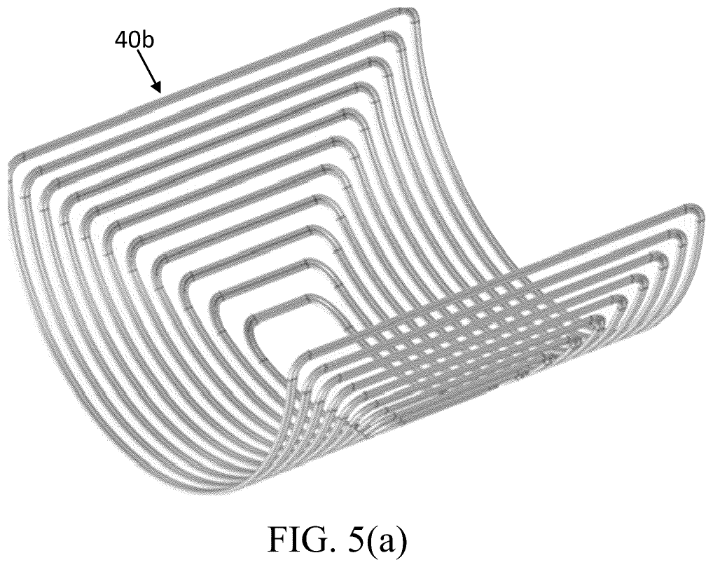

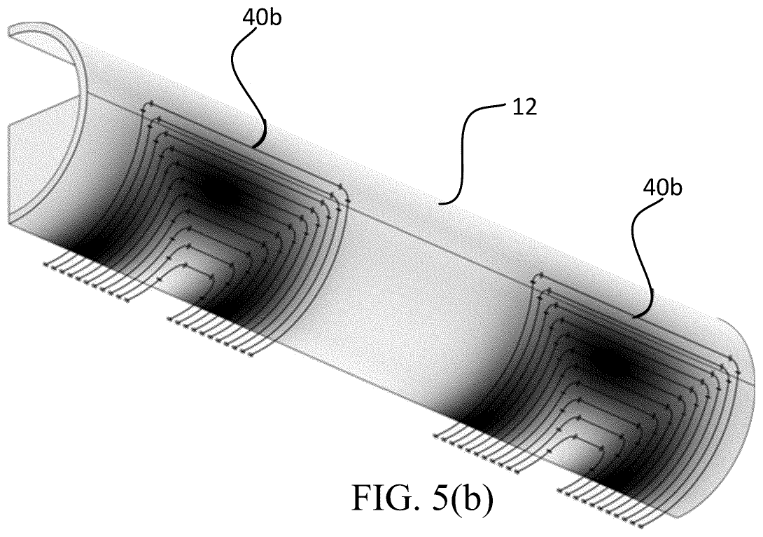

As illustrated in FIGS. 5(a) and 5(b), there is shown an alternate example of the induction coil 40b disposed within the induction coil assembly of the induction heating unit as previously described. The shown induction coil 40b comprises a pancake style coil structure, wherein the induction coil 40b is curved about a central latitudinal axis of the pancake style induction coil 40b to conform to the external curvature of the susceptor tube 12. In providing the curved pancake induction coil 40b as illustrated, the induction coil 40b maintains a consistent distance from the susceptor tube 12 to induce heat evenly into the susceptor tube 12. In the shown embodiment, the induction coil 40b extends across only a lower portion of the susceptor tube 12, wherein the lower portion is defined below a midline of the susceptor tube 12, to induce heat only into the lower portion where the plurality of DRI pellets contact the susceptor tube 12 as a result of gravity. In this manner, the efficiency of the pancake style induction coil 40b is substantially increased relative to the multiturn solenoidal induction coil (as shown in FIGS. 4(a) and 4(b), 40 a) described elsewhere herein. In the illustrated embodiment, the induction coil 40 b comprises a Litz wire construction, however in alternate embodiments, internally cooled tubular induction coils may be used.

The examples of the invention include reference to specific electrical components. One skilled in the art may practice the invention by substituting components that are not necessarily of the same type but will create the desired conditions or accomplish the desired results of the invention. For example, single components may be substituted for multiple components or vice versa.

Reference throughout this specification to “one example or embodiment,” “an example or embodiment,” “one or more examples or embodiments,” or “different example or embodiments,” for example, means that a particular feature may be included in the practice of the invention. In the description various features are sometimes grouped together in a single example, embodiment, figure, or description thereof for the purpose of streamlining the disclosure and aiding in the understanding of various inventive aspects.

The present invention has been described in terms of preferred examples and embodiments. Equivalents, alternatives and modifications, aside from those expressly stated, are possible and within the scope of the invention. Those skilled in the art, having the benefit of the teachings of this specification, may make modifications thereto without departing from the scope of the invention.

1. An auger driven feedstock induction heating system for transporting and preheating a feedstock, the system comprising:
a susceptor tube having a first end opposite a second end, wherein a feedstock inlet opening is disposed proximate to the first end and a feedstock outlet opening is disposed proximate to the second end;
one or more induction heating units disposed along an axial length of the susceptor tube, wherein each induction heating unit comprises a power source and an induction coil assembly;
wherein the power source is operably connected to an induction coil disposed within a coil housing of the induction coil assembly, the power source configured to output an alternating current to the induction coil to generate a magnetic field;
wherein the coil housing of each induction heating unit of the one or more induction heating units is at least partially disposed about a circumference of the susceptor tube and comprises an inner diameter dimensioned to conform to an outer diameter of the susceptor tube;
a layer of refractory material disposed between an inner wall of the coil housing and the induction coil, wherein the inner wall is adjacent to the susceptor tube;
an auger assembly comprising an auger operably connected to an auger motor, the auger having a central axle and an auger blade wrapped helically about the central axle at an auger pitch angle;
wherein the auger is disposed within the susceptor tube such that the central axle is coaxial with a central longitudinal axis of the susceptor tube, the central longitudinal axis bisecting each of a pair of perpendicular transverse axes of the susceptor tube; and
wherein the auger motor selectively rotates the auger about the central axle to drive a feedstock from the feedstock inlet opening to the feedstock outlet opening.

2. The system of claim 1, wherein the induction coil of each induction heating unit comprises a multiturn solenoidal construction having a consistent diameter, the induction coil surrounding an entire exterior circumference of the susceptor tube.

3. The system of claim 1, wherein the induction coil of each induction heating unit comprises a curved pancake coil structure positioned along a lower portion of the susceptor tube, such that no portion of the induction coil extends beyond a midline of the susceptor tube and wherein the induction coil is curved about a central latitudinal axis of the induction coil to conform to an external curvature of the susceptor tube.

4. The system of claim 1, further comprising one or more gas inlet pipes disposed through the susceptor tube and in fluid communication with an gas source, the one or more gas inlet pipes adapted to transport a gas from the gas source into an interior volume of the susceptor tube.

5. The system of claim 1, wherein the feedstock inlet opening is offset from an exterior surface of the susceptor tube via an extension tube segment defining a hopper extending from an upper side of the susceptor tube, wherein the feedstock inlet opening is disposed along a plane perpendicular to that of the feedstock outlet opening, wherein the feedstock outlet opening coincides with the second end of the susceptor tube.

6. The system of claim 1, wherein the feedstock inlet opening is offset from an exterior surface of the susceptor tube via an extension tube segment defining a hopper extending from an upper side of the susceptor tube, and wherein the feedstock outlet opening is disposed along an opposing lower side of the susceptor tube, the feedstock inlet opening and the feedstock outlet opening disposed on parallel planes.

7. The system of claim 1, wherein the feedstock comprises a plurality of feedstock pellets, each feedstock pellet of the plurality of feedstock pellets having a substantially equivalent diameter, and further wherein a radial length of the auger blade is dimensioned such that a distance between a distal end of the auger blade and an inner surface of the susceptor tube is less than the diameter of each feedstock pellet of the plurality of feedstock pellets.

8. The system of claim 1, further comprising an air cooling circuit defined between a blower unit affixed to each induction heating unit and a plurality of exhaust apertures disposed through at least a portion of an outer wall of the coil housing, the blower unit in communication with an interior of the coil housing via an air channel extending between the blower unit and the induction coil assembly, the blower unit configured to collect ambient air and circulate the ambient air through the air cooling circuit to convectively cool the induction coil.

9. The system of claim 8, further comprising a shroud disposed over the blower unit, wherein a plurality of inlet apertures are disposed through the shroud dimensioned to filter entrained particulate in the cooling air collected by the blower unit.

10. The system of claim 1, further comprising a support structure affixed to the susceptor tube and mounted on a work deck, wherein a height of the support structure proximate to each of the first end and the second end is independently adjustable such that a tilt angle of the susceptor tube relative to a plane of the work deck is selectively adjustable.

11. The system of claim 1, further comprising a flux concentrator disposed within the induction coil housing and partially surrounding the induction coil, the flux concentrator configured to direct the magnetic field towards the susceptor tube.

12. A method for transporting and preheating a feedstock via induction heating, the method comprising:
positioning a susceptor tube through one or more induction coil assemblies of one or more induction heating units, each induction coil assembly defining a coil housing having an induction coil therein;
supplying an alternating current from a power source disposed within each induction heating unit of the one or more induction heating units to each associated induction coil to generate a magnetic field configured to magnetically couple to and inductively heat the susceptor tube;
charging a feedstock into an interior volume of the susceptor tube via a feedstock inlet opening disposed through the susceptor tube;
rotating a central axle of an auger via an auger motor operably connected to the central axle, the auger disposed centrally within an interior volume of the susceptor tube, the central axis extending along a central longitudinal axis of the susceptor tube, the auger further comprising an auger blade helically wrapped about the central axle and disposed at an auger pitch angle;
whereupon rotation of the central axle the feedstock is agitated within the susceptor tube and transported from a first end of the susceptor tube to a second end of the susceptor tube, whereupon the feedstock exits the susceptor tube via a feedstock outlet opening disposed therethrough.

13. The method of claim 12, further comprising the step of adjusting one or more operational parameters of the alternating current supplied to each induction coil, the operational parameters comprising at least a power magnitude of the alternating current and a frequency of the alternating current, to produce a heating profile selected from a group consisting of:
a gradient heating profile wherein subsequent induction coils of the one or more induction coils disposed along an axial length of the susceptor tube induce progressively increasing or progressively decreasing heat in the susceptor tube from the first end to the second end; and
a uniform heating profile wherein the operational parameters of the alternating current supplied to each induction coil of the one or more induction coils are equivalent.

14. The method of claim 12, further comprising the steps of:
collecting ambient air via a blower unit affixed to each induction heating unit; and
circulating the ambient air through an air cooling circuit to convectively cool the induction coil, the air cooling circuit defined between the blower unit and a plurality of exhaust apertures disposed through at least a portion of an outer wall of the coil housing, wherein the blower unit is in communication with an interior of the coil housing via an air channel extending between the blower unit and the induction coil assembly.

15. The method of claim 12, further comprising the step of monitoring an internal temperature of the susceptor tube via one or more temperature sensors disposed along a length of the susceptor tube.

16. The method of claim 15, further comprising the step of adjusting a rotation speed of the auger to vary a residence time of the feedstock within the susceptor tube in response to feedback from the one or more temperature sensors.

17. The method of claim 12, wherein the charging step further comprises charging a quantity of feedstock sufficient to fill half of the interior volume of the susceptor tube.

18. The method of claim 12, further comprising the step of adjusting a support structure affixed to the susceptor tube and mounted on a work deck to elevate the first end of the susceptor tube relative to the second end of the susceptor tube.

19. The method of claim 12, further comprising the step of circulating a gas through a gas circuit defined between a gas source in communication with one or more gas inlet pipes affixed to the susceptor tube, an interior volume of the susceptor tube, and one or more exhaust outlet pipes affixed to the susceptor tube, each of the one or more gas inlet pipes and the one or more exhaust outlet pipes in fluid communication with the interior volume of the susceptor tube.

20. The method of claim 19, further comprising the step of adjusting a flowrate of the gas through the gas circuit to maintain the gas within the interior volume at a consistent internal pressure within the susceptor tube.
